(19) United States
(12) Patent Application Publication
(10) Pub. No.: US 2013/0008272 A1
(43) Pub. Date: Jan. 10, 2013

(54) Gear rim with elastic cassettes

(76) Inventor: Dmitriy A. Salov, Krasnoyarsk (RU)

(21) Appl. No.: 13/177,991

(22) Filed: Jul. 7, 2011

(51) Int. Cl. F16H 55/14

(52) U.S. Cl. 74/411

(57) ABSTRACT

The invention relates to machine building and may be used in large-size mechanism drives. A gear rim comprises a centre which is a whole piece or comprises at least two sectors. At least two elastic tooth cassettes are located on the sectors, each comprising an elastic metal sheet plate with cut teeth and a plate fixture system upon the centre. The invention allows to significantly increase the service life and reduce the total weight of the structure.

### FIELD OF THE INVENTION

The invention relates to machine building and may be used in large-size mechanism drives such as the sweep drives of excavators, gantry cranes, and the rotary drives of mills, crushers, rotating furnaces, etc.

### BACKGROUND ART

The gear rim of an excavator rotating platform mechanism is known to be described in USSR Author's Certificate No. 1164372, with its design including several interchangeable sections mounted upon the support base to facilitate the replacement thereof. The top surface of the support base have brackets welded thereto, the number of the brackets being equal to the number of sections with each section being secured to the bracket in two places. The known design provides for a segment by segment changeability and allows to replace the whole gear rim or a defective segment without removing the support base from under the excavator. At the same time each section of the known design is a whole non-demountable unit made of a whole workpiece. The material for such a workpiece is to be chosen depending on the requirements of teeth strength and hardness. With due regard for the fact that alloy steel and complicated shape pattern equipment is used to manufacture the sections and the sections themselves are disposable spare parts to be frequently replaced in the process of operation, the value of the whole design grows up significantly, especially on the condition that the section teeth, in other words the working part of the gear rim, are most vulnerable to wear and tear.

The problem to be solved by the proposed design is further improvement of the existing gear rim designs thus allowing to raise efficiency of the materials used, reduce the costs incurred in repairs, and meet the requirements to the general layout of the design. The technical results that can be achieved when solving this problem are a significant increase in the service life, a lower weight, higher quality of the finished product, an opportunity to manufacture gear rims with an over 2000 mm diameter, and elimination of the need to replace large-size parts during repairs.

It will be clearly understood that, if a prior art publication is referred to herein, this reference does not constitute an admission that the publication forms part of the common general knowledge in the art in Australia or in any other country.

Throughout this specification, the term “comprising” and its grammatical equivalents shall be taken to have an inclusive meaning unless the context of use indicates otherwise.

### SUMMARY OF THE INVENTION

It is an object of the present invention to provide a gear rim assembly which may overcome at least some of the abovementioned disadvantages, or provide a useful or commercial choice.

To achieve the above results a gear rim assembly is proposed comprising a centre, said centre being either a whole unit or comprising several sectors with their number being preferably even in number, each sector being made in the form of a welded rolled metal box-like body, and at least two elastic toothed cassettes, each comprising an elastic rolled or forged metal plate with cut teeth and a fixture system upon the centre.

In one aspect, the invention resides broadly in a gear rim assembly consisting of a centre which is a whole piece or comprises at least two sectors, each being made in the form of a rolled metal welded box-like body with at least two elastic tooth cassettes placed thereon, each cassette comprising an elastic plate of sheet metal with cut teeth and a fixture system located upon the centre.

Preferably but not necessarily the claimed design may comprise an elastic cassette fixture system upon the centre provided the elastic cassettes are tightly adjacent to the mating surface; the gear rim may additionally comprise an elastic cassette positioning system in the form of location pins secured to the centre surface contacting the cassettes and grooves in the relevant surface on the cassette plates; the thickness of the metal beneath the tooth in the cassette plate may not exceed 1.5 times the tooth height which makes the cassette elastic enough to assure good mating with the contact surface.

### DESCRIPTION OF THE DRAWINGS

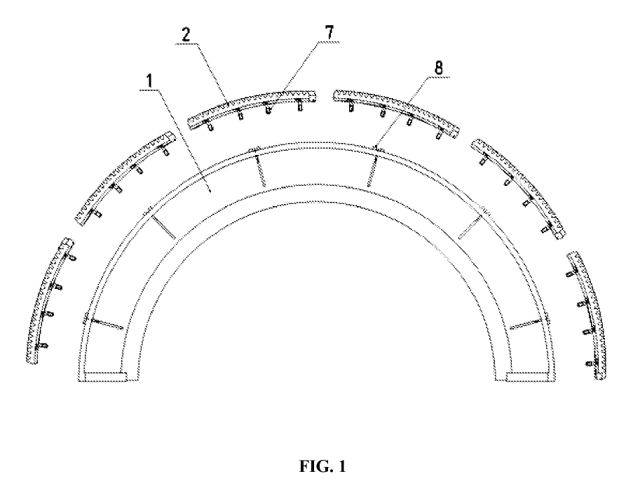

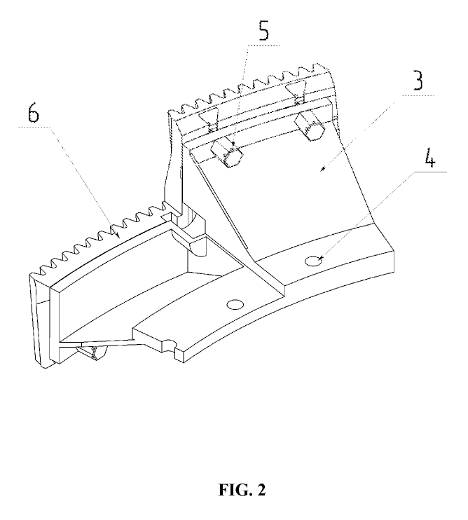

The invention is illustrated with the general view (FIG. 1) and the gear rim section (FIG. 2).

It will be appreciated that the drawings have been provided for the purposes of illustrating preferred embodiments of the present invention and that the invention should not be considered to be limited solely to the features as shown in the drawings.

In general the claimed gear rim consists of centre 1 with several elastic cassettes 2 mechanically secured to each sector of the gear rim. The centre is the main power element of the claimed design and assures the geometrical parameters of the gear rim during operation. The sector material is rolled sheet metal with sheets being electrically welded into box-like body 3. The advantages of this centre design are a lower weight and metal consumption with the operation properties intrinsic of traditional cast metal gear rims that are much heavier, being retained. Apertures 4 and 5 are provided in the centre and designed for fixing the gear rim to the mechanism and for fixing the tooth elastic cassettes to the centre. The latter consist of elastic plates 6 with cut straight and slant teeth on the one side and several rectangular section grooves on the side opposite to the teeth, with the groove surfaces mating the location pins on the centre surface. The elastic plates of the tooth cassettes are made of rolled or forged alloy steel and have rectangular sections. The use of rolled or forged metal allows to reduce the thickness of the metal layer beneath the tooth to the value not exceeding 1.5 of the tooth height, thus contributing to a significantly lower weight and production costs, at the same time making the cassette more elastic to assure its tight contact with the mating surface. Using rectangular section workpieces for the manufacture of cassettes allows to assure the detection of concealed defects by non-destructive control methods, which is impossible when using complicated shape workpieces, thus raising the quality of the cassettes per se and of the whole structure.

The gear rim is assembled by initially placing the elastic cassettes at the relevant places of installation upon the centre. Nuts 7 of the fixture system placed on the threaded parts of the elastic cassette fastening bolts apply the tightening force to the cassettes assuring their tight contact with the sector surface. To assure positioning and location of the cassettes in relation to each other within the limits of the tooth spacing, the gear rim design additionally provides for pins 8 secured to the centre surface contacting the cassettes and entering the cassette grooves.

Summing up the above, amongst the advantages arising from the use of rolled metal for the components of the claimed structure, a possibility of volume heat treatment of the cassette plates should be mentioned to attain the required hardness value. This will materially raise the quality of the structure and increase its service life, at the same time reducing its weight. Economic advantages of the claimed structure are also obvious as the price of the structure is reduced at the expense of a much lower weight of the components made of alloy steel as well as the cost of repairs as it is cassettes only that will have to be removed and not the whole gear rim structure which is much heavier and more expensive than the cassettes.

Those skilled in the art will appreciate that the present invention may be susceptible to variations and modifications other than those specifically described. It will be understood that the present invention encompasses all such variations and modifications that fall within its spirit and scope.

1. A gear rim assembly comprising a centre which is a whole piece or comprises at least two sectors, each being made in the form of a rolled metal welded box-like body with at least two elastic tooth cassettes placed thereon, each cassette comprising an elastic plate of sheet metal with cut teeth and a fixture system located upon the centre.

2. A gear rim assembly according to claim 1 additionally comprising a fixture system for the elastic cassettes upon the centre provided to assure a tight contact with the mating surface of the centre.

3. A gear rim assembly according to claim 1 or claim 2 additionally comprising an elastic tooth cassette positioning system in the form of pins secured to the centre surface contacting the cassettes and mating grooves cut on the relevant surface of the cassette elastic plate.

4. A gear rim assembly according to any one of the preceding claims wherein the thickness of the metal layer beneath the tooth on the cassette plate is a maximum of 1.5 times the tooth height, which renders the cassette elasticity required for quality operation.

5. A gear rim assembly substantially as hereinbefore described with reference to the drawings.
